(19) United States
(12) Patent Application Publication
(10) Pub. No.: US 2012/0278159 A1
(43) Pub. Date: Nov. 1, 2012

(54) METHOD AND APPARATUS FOR ENHANCING CUSTOMER SERVICE EXPERIENCE

(76) Inventors: Gangadharan KUMAR, Bangalore (IN); Ravi VIJAYARAGHAVAN, Bangalore (IN)

(21) Appl. No.: 13/454,726

(22) Filed: Apr. 24, 2012

Related U.S. Application Data
(60) Provisional application No. 61/479,809, filed on Apr. 27, 2011.

(51) Int. Cl. G06Q 30/02; G06F 17/30; G06Q 10/00

(52) U.S. Cl. 705/14.42; 705/14.54; 705/304; 705/14.45; 707/713; 707/E17.017

(57) ABSTRACT

A technique is taught that improves how an organization engages with customers. In an embodiment, keywords are discovered to optimize for, and to integrate with, advertising systems to advertise a company website. A set of advertisements is created that improve the click-through rate from users. A optimized landing page experience is created to provide a best user experience to drive issue resolution and sales.

### CROSS REFERENCE TO RELATED APPLICATIONS

This application claims priority to provisional patent application Ser. No. 61/479,809, filed Apr. 27, 2011, which application is incorporated herein in its entirety by this reference thereto.

### BACKGROUND OF THE INVENTION

1. Technical Field

The invention relates to customer relationship management. More particularly, the invention relates to enhancing the customer's experience when resolving issues that relate to a product or a service on the Internet.

2. Description of the Background Art

Currently, when a customer of a company faces any issues with respect to a service or a product, the customer typically contacts customer service representatives of the company, either by phone, chat, or any other available media. The customer service representatives attempt to solve the customer's issues by spending time to understand these issues, offering appropriate solutions, and so on.

In many cases, the solution to the customer's issue is quite common and the issue, along with the solution to the issue, may be available on the website of the company. This may result in the customer service representative wasting time and spending effort in solving an issue, which the customer may have been able to solve himself by using the information on the Internet or on the website of the company.

In cases, where the customer searches for a solution to the issue using a search engine, the appropriate page on the company's website may not be immediately visible to the customer because it may not appear among the first few results in the search engine. This leads to a situation where the customer is unable to find a solution to his issue on the Internet and, therefore, contacts the customer care representative using more expensive means, such as voice.

The customer may not be able to view the correct solution due to a lack of adequate steps taken by the company to ensure that the solution is accessible to the customer on the Web. The company may not be aware that customers are facing issues in a particular area and, hence, does not make the related page sufficiently prominent to grab the attention of the customer. The company may also not have optimized the related Web page for visibility to search engines.

Further, the company may be relying on traditional media, such as telephone-based customer service representatives, to assist customers, and makes no effort to provide the related information on the Web, either on the company website or on some other related website. For example, in relation to servicing a technical product, it may be better to have generic FAQs listed on the website, so that customers can read about commonly faced issues.

For specific technical issues, a chat service may be provided for online support where a customer service representative goes through the issue with the customer and provides necessary support services to the resolve the issues that the customer is facing.

Therefore, the level of service offered may be dependent on the level of involvement required from the customer service representatives. Companies cannot afford to resolve all issues by engaging with the customers directly. At the same time, there are certain issues that can be resolved by engaging with a customer either through a chat or over a telephone call or similar means. Therefore, it is important for companies to have the right mix of means to address the various kinds of issues faced by their customers.

### SUMMARY OF THE INVENTION

Embodiments of the invention provide a method and apparatus for discovering keywords to optimize for, and to recommend, the optimizations needed on a company website to improve the visibility of the website during customer searches, where such searches are any of an external search and an internal search.

Embodiments of the invention also provide a method and apparatus for discovering keywords to optimize for, and to integrate with, a company's advertising systems to advertise the website with the intent of creating awareness and increasing visibility of, and driving traffic to, the website. Embodiments of the invention also optimize for the right tactic and the right bid to enable the website to be prominent among search related advertisements.

Embodiments of the invention also provide a method and apparatus for creating the right set of advertisements to improve customer click-through, and thus serve the needs of the customer by resolving issues faced by the customer and/or providing information about a product/service to the customer. Embodiments of the invention also provide a method and apparatus that creates multiple versions of advertisements to test the efficacy of the advertisements and improve the advertisements based on the efficacy of the advertisements.

Embodiments of the invention also provide a method and apparatus for creating the right landing page experience when a customer clicks through the ads/search, and to optimize for the right customer experience to drive resolution/sales. Embodiments of the invention also provide a method and apparatus for offering additional services, such as assisted self-service and/or chat, from the landing pages. Embodiments of the invention also provide a method and apparatus for customization of the landing page experience for different customers based on various parameters, such as geographic location of the customer, intent as expressed by the keyword, etc.

### BRIEF DESCRIPTION OF THE DRAWINGS

FIG. 1 is a block schematic diagram showing a system for enhancing the customer service experience according to the invention;

FIG. 2 is a flow diagram showing a method for enhancing the customer service experience according to the invention;

FIG. 3 is a flow diagram showing an example of a primary issue line identification according to the invention;

FIG. 4 is a flow diagram showing a further example of a primary line issue line identification according to the invention;

FIG. 5 is a flow diagram showing a text mining technique according to the invention;

FIG. 6 is a flow diagram showing a method for identifying keywords according to the invention; and

FIG. 7 is a block schematic diagram showing a machine in the exemplary form of a computer system within which a set of instructions for causing the machine to perform any of the herein disclosed embodiments of the invention may be executed.

### DETAILED DESCRIPTION OF THE INVENTION

The embodiments herein disclose a method and apparatus for enabling a company/organization to engage with customers/users.

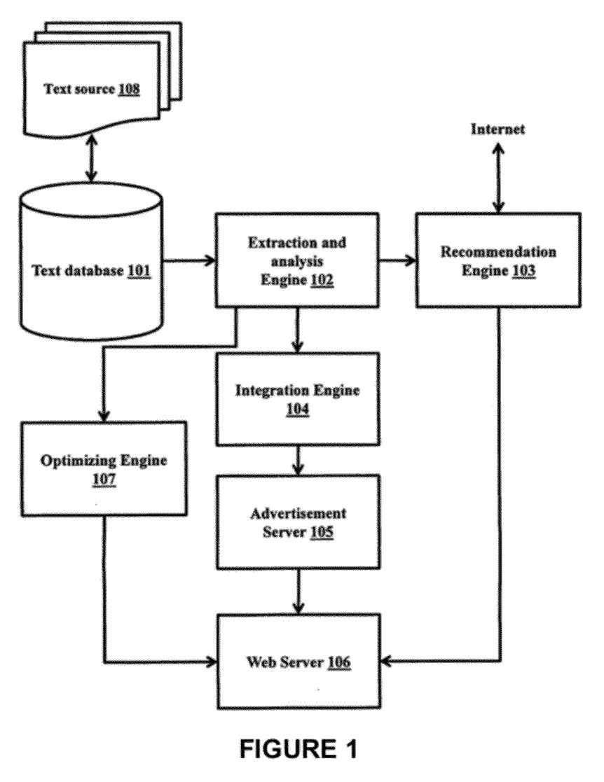

FIG. 1 depicts a system, according to embodiments as disclosed herein, that comprises of a text database 101, an extraction and analysis engine 102, a recommendation engine 103, an integration engine 104, an advertisement server 105, and a Web server 106.

In an embodiment, the text database 101 contains information that is in a text format. The information is collected from a plurality of sources 108 including, but not limited to, chat conversations between customer service representatives and customers, customer management data, social media interactions, transcripts of voice conversations between customer service representatives and customers, search terms used on search engines, search terms used on the website of companies, Web logs maintained by a website, forum postings related to the companies, electronic mails sent by the customers related to the company, blogs, and/or any other text related to information that is of interest to the customers.

The advertisement server 105 comprises one or more servers which host Web advertisements. The advertisements are served to a customer when a customer is viewing a page by the advertisement server 105 on the basis of the type of page being viewed by the customer. In other embodiments, the advertisements are also served to the customer when the customer is performing a search using a particular keyword, where the displayed advertisement depends on the keyword used by the customer. The advertisement server 105 also enables a bidding process for the advertisements, where multiple bidders may bid for the right to display their advertisement for a keyword that is used by a customer when performing a search.

The extraction and analysis engine 102 fetches text from the text database 101. The extraction and analysis engine 102 analyzes the text and identifies issues faced by the customer. The issues identified are typically the most common issues that are of concern to, or raised by, the customer, which issues are identified during customer activities, such as contacting the customer service representative, making searches, posting in forums, blogs, and so on.

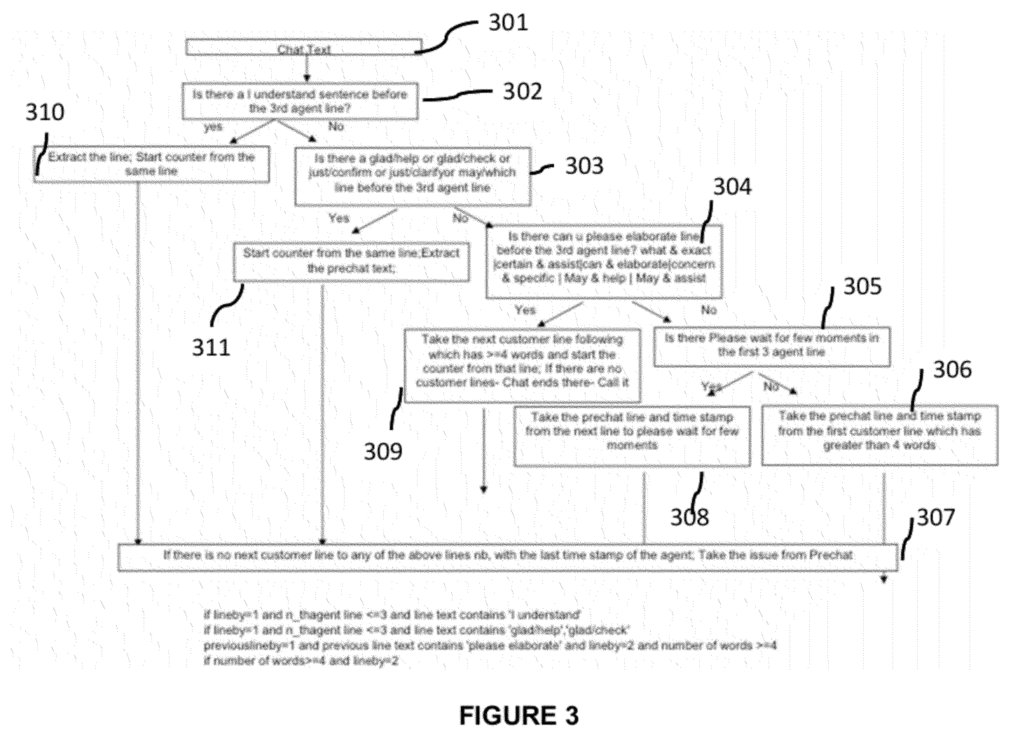

The extraction and analysis engine 102 identifies keywords associated with the issues faced by the customer. The keywords are identified from the text and identifying words and terms used by the customer for describing the problem. In other embodiments, the keywords are also identified on the basis of the words and terms used while attempting to solve the issues faced by the customer, e.g. by the customer service representative, participants in a forum and so on. The identified keywords are, for example, in the form of keywords or phrases. Keywords are identified based on a text mining issue categorization solution that mines chat transcripts, voice transcripts, forum logs, blogs, etc. The essential logic of such solution concerns the way in which a customer talks about an issue in one or more channels provides the phrases that are likely to be the phrases that they customer uses for a search as well. An embodiment of the invention uses the algorithm shown in FIGS. 3-5 for this purpose.

The recommendation engine 103 receives the keywords from the extraction and analysis engine 102. In an embodiment, the recommendation engine 103 connects to the Internet and runs searches for each of the received keywords. The searches are run, for example, using a suitable search engine, such as Google, Bing, Yahoo, and so on. In an embodiment, the searches are also run on the website of a company, where the website has a search engine for searches on that website. This search does not necessarily require an algorithm. Rather, embodiment of the invention use a software system that automatically runs the search, e.g. through well known, published APIs of the search engines that are used. The idea here is to do regular search.

The results are analyzed through automated mechanisms, e.g. some form of text matching, to check the ranking of the Web page of the company which offers the solution to the issue, as laid out by the used keywords. If the ranking of the Web page is low, i.e. the Web page is not among the first few results, the recommendation engine 103 analyzes the Web page in the context of the keywords and the search engine results and provides recommendations on how to optimize the Web page increase the visibility of the Web page during searches, typically by examining usage of the keywords in the content of the Web pages and then increase the overall content in the website for these significant keywords.

The recommendation engine 103 repeats the above mentioned process for each of the keywords received from the extraction and analysis engine 102. In an embodiment, the recommendation engine 103 also provides multiple recommendations for a particular keyword. In another embodiment, the recommendation engine 103 also modifies the Web page in the Web server as per the recommendations. The recommendation engine 103 typically presents the recommendations on a suitable display.

The integration engine 104 receives the keywords from the extraction and analysis engine 102. The integration engine 104 analyzes the keywords and discovers the appropriate catchphrases for purposes of bringing the appropriate Web pages belonging to the company to the notice of the customer. See below. In an embodiment, the appropriate Web pages are brought to the notice of the customer using appropriate advertisements, which are inserted into Web pages, where the Web pages are the result pages in search engines. In an embodiment, this is done by participating in the search engine advertising (marketplace). There are the systems for this purpose offered by companies, such as Google® (Adwords®) and Microsoft® (AdCenter®).

The customers view the advertisement on performing a search with the specified catchphrases and view the appropriate Web page by clicking on the advertisement. The integration engine 104, in conjunction with at least one advertisement server 105, also decides on bids to be placed with the advertisement server 105, so that the advertisement for the Web page comes among the first few results when a customer enters the catchphrase or a phrase similar to the catchphrase. In an embodiment, the price of the bid is calculated on the amount that a client is willing to spend to resolve the specific issues represented through the keyword. Overall, the cost of acquiring and servicing the customer online should be lower than what it would be for servicing the same customer through the voice channel, hence delivering value.

The integration engine 104 deploys the advertisement with the help of the advertisement server 105 and the Web server 106. The integration engine 104 also monitors the number of clicks generated from each deployed advertisement. In an embodiment, the integration engine 104 also provides multiple catchphrases for the same keyword and deploys multiple advertisements, based on the provided multiple catchphrases. The integration engine 104 monitors the number of clicks generated from each deployed advertisement and modifies or removes certain advertisements, depending on the number of clicks generated from each deployed advertisement. In an embodiment, the system collects the data associated with the number of times the ads were clicked and, hence, the Web pages visited as directed by the ads. The Web pages, i.e. landing pages for the ads, are instrumented to collect the required data and analyzed subsequently.

The optimization engine 107 receives the keywords from the extraction and analysis engine 102. The optimization engine 107 optimizes the Web page to make it easy for the customer to view solutions to their queries. See below. In an embodiment, the optimization engine 107 also modifies the Web page to offer additional issue solving techniques, such as chat, assisted self service, and so on, to assist the customer. The optimization engine 107 also modifies the Web page on a per-user basis. The modifications are based on a plurality of factors comprising, for example, geographic location of the end user and intent of the user, which are deduced from the keyword used by the customer.

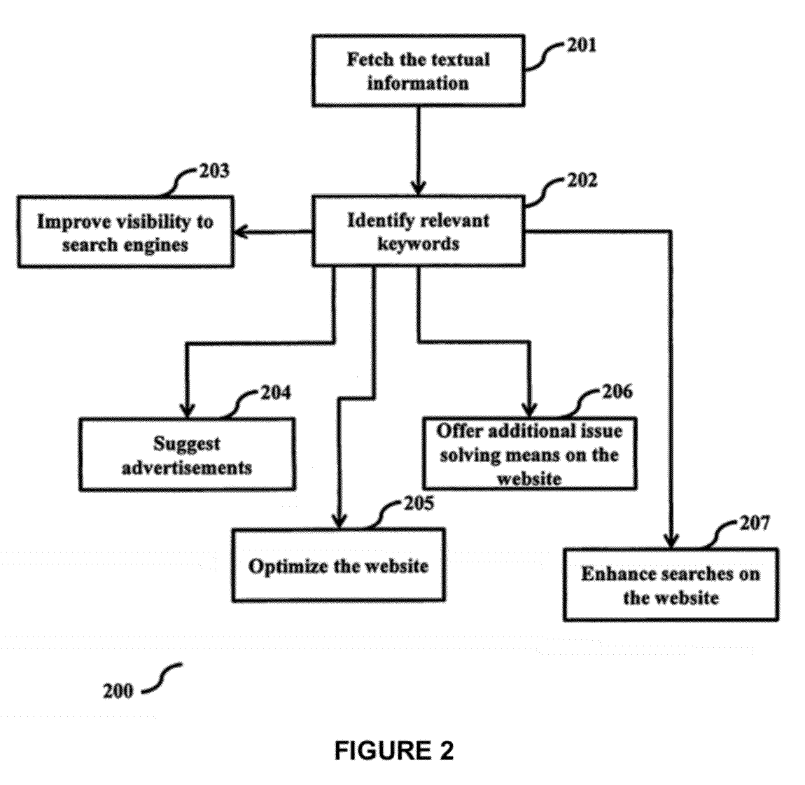

FIG. 2 is a flowchart showing a method for enhancing the customer service experience according to an embodiment of the invention. The extraction and analysis engine 102 fetches (201) text from the text database 101. The extraction and analysis engine 102 identifies (202) relevant keywords associated with the issues faced by the customer by analyzing the text and identifying issues faced by the customer which are identified, for example, from the text and identifying words and terms used by the customer for describing the problem e.g. using text mining and extraction, as described above in connection with FIGS. 3-5.

The keywords are also identified on the basis of the words and terms used while attempting to solve the issues faced by the customer, for example, by the customer service representative, participants in a forum, and so on. In an embodiment, the identified keywords are in the form of keywords or phrases. The recommendation engine 103 enhances (203) the visibility of the page to search engines using the relevant keywords sent by the extraction and analysis engine 102. See below. The recommendation engine 103 provides recommendations on how to optimize the Web page to increase the visibility of the Web page to search engines. In an embodiment, the recommendation engine 103 also modifies the Web page in the Web server as per the recommendations, for example through ads (see below).

The integration engine 104 suggests (204) appropriate advertisements for insertion into the search result pages on search engines using the relevant keywords sent by the extraction and analysis engine 102. The integration engine 104 analyzes the keywords and discovers the appropriate catchphrases for purposes of bringing the appropriate Web pages belonging to the company to the notice of the customer by inserting appropriate advertisements.

The integration engine 104, in conjunction with at least one advertisement server 105, also decides on bids to be placed with the advertisement server 105, so that the advertisement for the Web page is provided among the first few results, thus enhancing the visibility of the page when a customer enters the catchphrase or a phrase similar to the catchphrase, e.g. by leveraging the mechanisms exposed by the advertising systems.

The optimization engine 107 optimizes (205) the Web page to make it easy for the customer to view solutions to their queries easily, for example by exploring different mechanisms of presenting the information to the end user and by leveraging historical data of performance of various presentations.

The optimization engine 107 also modifies (206) the Web page to offer additional issue solving techniques, such as chat, assisted self service, and so on to assist the customer. The recommendation engine 103 enhances (207) the visibility of the page during searches conducted only on the Web site by using the relevant keywords sent by the extraction and analysis engine 102.

In an embodiment, Steps 203-207 are performed simultaneously, one after the other. Steps 203-207 may also be performed one after the other, with no mandatory order of steps being followed. A combination of one or more steps from 203-207 may also be performed. The various actions in method 200 may be performed in the order presented, in a different order, or simultaneously. Further, in some embodiments, some actions listed in FIG. 2 may be omitted.

FIG. 3 is a flow diagram showing an example of a primary issue line identification according to the invention.

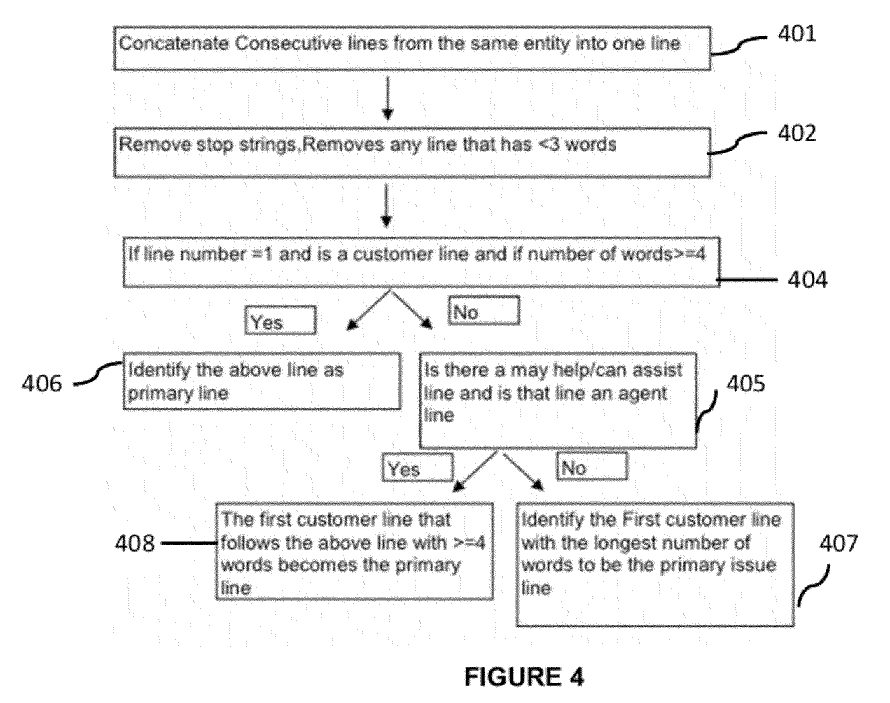

FIG. 4 is a flow diagram showing a further example of a primary line issue line identification according to the invention.

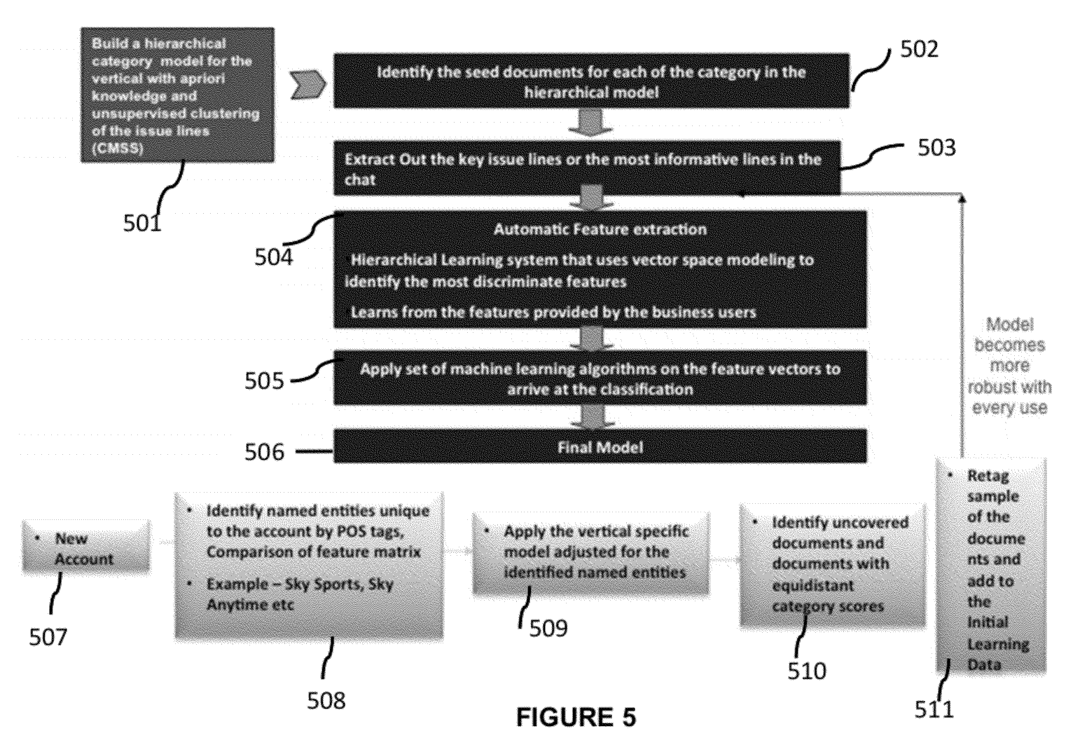

FIG. 5 is a flow diagram showing a text mining technique according to the invention.

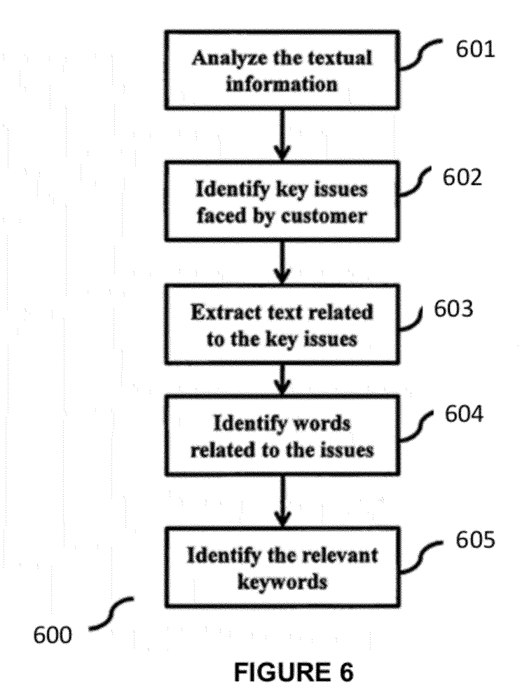

FIG. 6 depicts a process for identifying keywords according to an embodiment of the invention. The extraction and analysis engine 102 analyzes (301) the textual information fetched from the text database 101. From the textual information, the extraction and analysis engine 102 identifies (302) key issues faced by the customer (see FIGS. 3-5 and the discussion thereof above, for example) The issues identified are typically the most common issues raised the customer, for example, when contacting the customer service representative, making searches, posting in forums and blogs, and so on.

In an embodiment, the extraction and analysis engine 102 also considers the frequency of occurrence of these key issues by looking at the frequency of occurrence of the relevant text. The extraction and analysis engine 102 extracts (303) text related to the issues from the textual information and identifies (304) words associated with those issues. The extraction and analysis engine 102 then identifies (305) the keywords using the associated words.

The various actions in method 300 may be performed in the order presented, in a different order, or simultaneously. Further, in some embodiments, some actions listed in FIG. 6 may be omitted.

Embodiments as disclosed above are explained using customer service as an example. It may be obvious to a person of ordinary skill in the art to use the embodiments as disclosed above in any scenario where the company/organization wants to engage with a customer/user, such as where a prospective customer is looking to purchase a specific product/service.

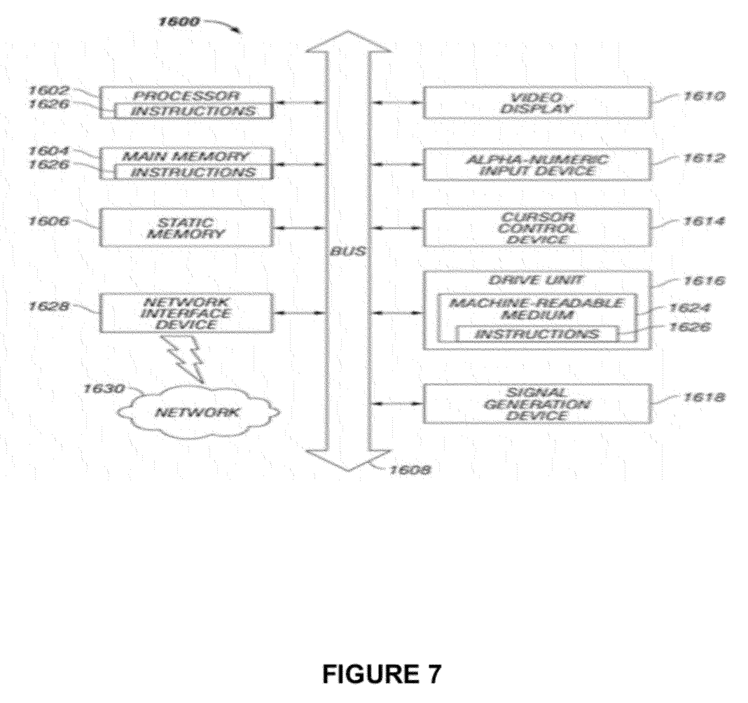

FIG. 7 is a block schematic diagram showing a machine in the exemplary form of a computer system 1600 within which a set of instructions for causing the machine to perform any of the herein disclosed techniques may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e., software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to preferred embodiments, one skilled in the art will readily appreciate that other applications may be substituted for those set forth herein without departing from the spirit and scope of the invention. Accordingly, the invention should only be limited by the Claims included below.

1. An apparatus, comprising:
a text database containing information in a predetermined format;
an extraction and analysis engine configured for fetching text from the text database, said extraction and analysis engine configured for identifying keywords associated with queries from a customer, wherein said keywords are identified from the text and from identifying words and terms used by the customer for in connection with said queries;
a recommendation engine configured for receiving the keywords from the extraction and analysis engine, wherein said recommendation engine runs searches for said received keywords, to determine the standing of an organization's website against the keywords;
an integration engine configured for receiving keywords from the extraction and analysis engine; and
an optimization engine configured for receiving the keywords from the extraction and analysis engine to optimize content on a Web page to assist the customer based on the keywords extracted and analysed.

2. The apparatus of claim 1, further comprising:
a processor configured for discovering keywords to optimize for, and to recommend optimizations needed, on a website to improve visibility of the website during searches.

3. The apparatus of claim 1, said optimization engine further comprising:
a processor configured for optimizing for, and for integrating with, advertising systems to advertise a website to create awareness, increase visibility, and drive traffic to a website, and to optimize for a correct tactic and a correct bid to enable the website to be prominent among search related advertisements.

4. The apparatus of claim 1, said optimization engine further comprising:
a processor configured for creating a correct set of advertisements to improve click-through from a customer to serve said customer in resolving issues faced by the customer and/or providing information about a product/service to the customer.

5. The apparatus of claim 1, said optimization engine further comprising:
a processor configured for creating multiple versions of advertisements to test efficacy of the advertisements and improve the advertisements based on the efficacy of the advertisements.

6. The apparatus of claim 1, said optimization engine further comprising:
a processor configured for creating a correct landing page experience in response to a customer clicking-through ads and/or searching, and for optimizing for a correct customer experience to drive resolution and/or sales.

7. The apparatus of claim 1, said optimization engine further comprising:
a processor configured for offering additional services comprising any of assisted self-service and/or chat from the landing pages.

8. The apparatus of claim 1, said optimization engine further comprising:
a processor configured for customizing a landing page experience for different users based on predetermined parameters.

9. The apparatus of claim 1, wherein said extraction and analysis engine analyzes the text and identifies issues faced by a customer, wherein said issues identified comprise the most common issues that are of concern to, or raised by, the customer, which issues are identified during customer activities, wherein said customer activities comprise any of contacting the customer service representative, making searches, and posting in forums and/or blogs.

10. The apparatus of claim 1, wherein said information is collected from a plurality of sources comprising any of chat conversations between customer service representatives and customers, customer management data, social media interactions, transcripts of voice conversations between customer service representatives and customers, search terms used on search engines, search terms used on company websites, Web logs maintained by a website, forum postings related to a company, electronic mails sent by customers related to a company, blogs, and/or any other text related to information of interest to customers.

11. The apparatus of claim 1, wherein said integration engine analyzes the keywords and discovers the appropriate catchphrases for purposes of bringing the appropriate Web pages belonging to the company to the notice of the customer.

12. The apparatus of claim 1, further comprising:
at least one advertisement server configured to host Web advertisements, wherein said advertisements are served to a customer when a customer is viewing a page based upon the type of page being viewed by the customer.

13. The apparatus of claim 1, wherein said optimization engine optimizes a company Web page to make it easy for the customer to view responses to their queries.

14. The apparatus of claim 12, wherein advertisements are served to the customer when the customer is performing a search using a particular keyword, where the displayed advertisement depends on the keyword used by the customer.

15. The apparatus of claim 12, wherein the advertisement server is configured to enable a bidding process for advertisements, where multiple bidders may bid for the right to display their advertisement for a keyword that is used by a customer when performing a search.

16. The apparatus of claim 1, wherein keywords are identified on the basis of the words and terms used while attempting to solve issues faced by the customer.

17. The apparatus of claim 1, wherein said recommendation engine runs searches for each of the keywords received from the extraction and analysis engine.

18. The apparatus of claim 1, wherein said recommendation engine provides multiple recommendations for a particular keyword.

19. The apparatus of claim 1, wherein recommendation engine modifies a Web page in a Web server as per recommendations received from the recommendation engine.

20. The apparatus of claim 1, wherein said integration engine, in conjunction with at least one advertisement server, decides on bids to be placed with the advertisement server so that an advertisement for a Web page is among the first few results when a customer enters a catchphrase or a phrase similar to the catchphrase;
wherein the position where the ads show up is indirectly influenced, but not controlled by said bids.

21. The apparatus of claim 1, wherein said integration engine deploys an advertisement with the help of an advertisement server and a Web server.

22. The apparatus of claim 21, wherein said integration engine monitors a number of clicks generated from each deployed advertisement.

23. The apparatus of claim 21, wherein said integration engine provides multiple catchphrases for a same keyword and deploys multiple advertisements, based on the provided multiple catchphrases.

24. The apparatus of claim 21, wherein said integration engine monitors a number of clicks generated from each deployed advertisement and modifies or removes certain advertisements, depending on the number of clicks generated from each deployed advertisement.

25. The apparatus of claim 1, wherein said optimization engine modifies a Web page using a repository of issues and resolutions and mining algorithms to determine co-occurring issues, wherein a combination of each is leveraged and presented on a Web page to offer issue solving techniques to assist the customer.

26. The apparatus of claim 1, wherein said optimization engine modifies a Web page on a per-customer basis.

27. A method for enhancing a customer service experience, comprising:
an extraction and analysis engine fetching text from a text database;
said extraction and analysis engine identifying relevant keywords associated with issues faced by a customer by analyzing the text, and identifying issues faced by the customer from the text and by identifying words and terms used by the customer for describing the issues;
wherein said keywords are also identified on the basis of the words and terms used while attempting to solve the issues faced by the customer;
a recommendation engine enhancing visibility of a page to search engines using relevant keywords sent by the extraction and analysis engine;
said recommendation engine providing recommendations on how to optimize a Web page to increase visibility of the Web page to search engines;
wherein said recommendation engine also modifies the Web page in the Web server as per said recommendations;
an integration engine suggesting appropriate advertisements for insertion into a search result page on search engines using relevant keywords sent by the extraction and analysis engine;
said integration engine analyzing the keywords and discovering appropriate catchphrases bring appropriate Web pages belonging to a company to the notice of the customer by inserting appropriate advertisements;
said integration engine, in conjunction with at least one advertisement server, deciding on bids to be placed with the advertisement server, so that advertisements for a Web page are provided among a first few results, thus enhancing the visibility of the page when a customer enters the catchphrase or a phrase similar to the catchphrase;
an optimization engine optimizing the Web page to make it easy for the customer to view solutions to their queries easily;
said optimization engine modifying the Web page to offer additional issue solving techniques to assist the customer; and
said recommendation engine enhancing visibility of the page during searches conducted only on the Web site by using the relevant keywords sent by the extraction and analysis engine.

28. A method for identifying keywords, comprising:
an extraction and analysis engine analyzing textual information fetched from a text database;
from the textual information, said extraction and analysis engine identifying key issues faced by a customer;
wherein said issues identified are those most common issues raised the customer.

29. The method of claim 28, said extraction and analysis engine also considering a frequency of occurrence of said key issues by looking at a frequency of occurrence of relevant text;
the extraction and analysis engine extracting text related to the issues from the textual information and identifying words associated with those issues; and
the extraction and analysis engine identifying the keywords using the associated words.
